(19) United States
(12) Patent Application Publication
(10) Pub. No.: US 2014/0074565 A1
(43) Pub. Date: Mar. 13, 2014

(54) SYSTEM AND METHOD FOR HUMAN RESOURCE PERFORMANCE MANAGEMENT

(71) Applicant: CLIFTON E. GREEN, NEWPORT NEWS, VA (US)

(72) Inventor: CLIFTON E. GREEN, NEWPORT NEWS, VA (US)

(21) Appl. No.: 14/017,212

(22) Filed: Sep. 3, 2013

Related U.S. Application Data
(60) Provisional application No. 61/699,194, filed on Sep. 10, 2012.

(51) Int. Cl. G06Q 10/06

(52) U.S. Cl. CPC G06Q 10/06398
USPC 705/7.42

(57) ABSTRACT

A system and method for evaluating personnel within a hierarchical organization by utilizing networked computer systems and programmed software. The invention provides accurate ratings of personnel and groups of personnel within an organization. The ratings are based on frequent feedback and are easy to compare. The invention allows for effective comparisons of individuals from separate organizations. The invention addresses the problem of rater inflation without the negative outcomes associated with existing forced distribution methods.

### CROSS-REFERENCE TO RELATED APPLICATIONS

This application claims priority to U.S. Provisional Application Ser. No. 61/699,194, filed Sep. 10, 2012, the contents of which are incorporated herein by reference in its entirety.

### FIELD OF THE INVENTION

The present invention relates to systems and methods for evaluating personnel within a hierarchical organization.

### BACKGROUND

Evaluation systems that measure a rated individual's (hereafter referred to as a ratee) performance against a stated objective, task, or competency have been around for many years. These systems provide ratees, their supervisors, and managers with data that can be used to assess the quality of the contribution that an individual is making to the organization. The data is also often used to support personnel actions, bonuses, and salary determinations.

However, these evaluation systems suffer from a number of flaws. First, systems that allow raters to choose ratings for their employees eventually find that the average rating creeps upward over time, a process known as rating inflation. Some systems use various methods to counteract this, such as forced distribution of the ratings (e.g. 20% A's, 70% B's, 10% C's) or reviewers who oversee the work of the raters. Unfortunately, these methods are ineffective in the long run and may be perceived as punitive and arbitrary by employees.

Second, existing evaluation systems do a poor job of creating useful feedback from raters to ratees. Most evaluation systems rely on extensive blocks of narrative text produced at infrequent intervals (>90 days apart.) This structure is not conducive to establishing accurate expectations, nor does it enhance the rater-ratee relationship.

Third, existing evaluation systems segregate user data, often to the point of making the data useless. Individuals who are coworkers are not able to view the objectives, tasks, or ratings assigned to other members of the organization. The same is true for individuals in other parts of the organization or even in other organizations. This lack of transparency is detrimental to creating effective work environments.

### BRIEF SUMMARY

In one embodiment of the invention, a computer-implemented method for human resource management comprises: receiving from a rater one or more numeric performance ratings for each of one or more performance elements for each of a plurality of ratees over a predetermined period of time; calculating, based on the one or more numeric performance ratings received from the rater, a performance score for each of the one or more performance elements for each of the plurality of ratees over the predetermined time period; calculating an inflation coefficient which provides a numeric indicator of how inflated the one or more numeric performance ratings received from the rater are compared to a predefined normalization average; calculating an inflation adjusted performance score for each of the one or more performance elements for each of the plurality of ratees by multiplying each of the one or more performance elements for each of the plurality of ratees by the inflation coefficient; and displaying the inflation adjusted performance score for each of the one or more performance elements for each of the plurality of ratees.

The inflation coefficient may be calculated by I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the one or more performance ratings received from the rater.

The method may further comprise calculating an inflation number which provides a numeric display of how inflated the one or more numeric performance ratings received from the rater are compared to the predefined normalization average, and displaying the calculated inflation number. The inflation number may be calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

Calculating, based on the one or more numeric performance ratings received from the rater, a performance score for each of the one or more performance elements may comprise calculating an average of the one or more numeric performance ratings for each of the one or more performance elements over a predetermined time period.

Receiving from a rater one or more numeric performance ratings for each of one or more performance elements for a ratee over a predetermined period of time may comprise receiving from a rater one or more interim numeric performance ratings over the predetermined time period and a final numeric performance rating at an end of the predetermined time period for each of one or more performance elements for a rate. Calculating, based on the one or more numeric performance ratings received from the rater, a performance score for each of the one or more performance elements may comprise calculating an average or a weighted average of the one or more interim numeric performance ratings and the final numeric performance rating for each of the one or more performance elements over a predetermined time period.

Calculating a weighted average of the one or more interim numeric performance ratings and the final numeric performance rating for each of the one or more performance elements over a predetermined time period may comprise assigning a fifty percent weight to an average of the one or more interim numeric performance ratings and a fifty percent weight to the final numeric performance rating.

The method may further comprise calculating an overall performance score for each of the plurality of ratees by averaging the calculated performance score for each of the one or more performance elements for each of the plurality of ratees. The inflation coefficient may be calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

The method may further comprise receiving from a workgroup rater a numeric workgroup performance rating for each of a plurality of workgroups, and adjusting the calculated performance score for each of the one or more performance elements for each of the plurality of ratees based on the workgroup performance ratings for some or all workgroups to which each ratee belongs.

The method may further comprise calculating a weighted value of each workgroup performance rating by multiplying each workgroup performance rating by a number of ratees in the corresponding workgroup, calculating a workgroup inflation coefficient which provides a numeric indicator of how inflated the numeric workgroup performance ratings received from the workgroup rater are compared to a predefined workgroup normalization average, and calculating an inflation adjusted workgroup performance rating for each workgroup by multiplying each workgroup performance rating by the workgroup inflation coefficient. The inflation coefficient may be calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance rating for the workgroups rated by the same rater.

Each workgroup may comprise at least one supervisor and at least one subordinate of that supervisor; wherein the workgroup rater for each workgroup comprises a supervisor of at least one supervisor in the respective workgroup.

Each workgroup may comprise at least one supervisor and at least one subordinate of that supervisor; wherein the workgroup rater for each workgroup comprises a direct supervisor of a top level supervisor in the respective workgroup.

In addition to the method for human resource management, as described above, other aspects of the present invention are directed to corresponding systems and computer program products for human resource management.

In another embodiment of the invention, a computer-implemented method for human resource management comprises receiving from a rater one or more numeric performance ratings for each of one or more performance elements for each of a plurality of ratees over a predetermined period of time, calculating, based on the one or more numeric performance ratings received from the rater, a performance score for each of the one or more performance elements for each of the plurality of ratees over the predetermined time period, calculating an inflation coefficient which provides a numeric indicator of how inflated the one or more numeric performance ratings received from the rater are compared to a predefined normalization average, calculating an inflation adjusted performance score for each of the one or more performance elements for each of the plurality of ratees by multiplying each of the one or more performance elements for each of the plurality of ratees by the inflation coefficient, receiving from a workgroup rater a numeric workgroup performance rating for each of a plurality of workgroups, and adjusting the inflation adjusted performance score for each of the plurality of performance elements for each of the plurality of ratees based on the workgroup performance ratings for some or all workgroups to which each ratee belongs.

The method may further comprise calculating a weighted value of each workgroup performance rating by multiplying each workgroup performance rating by a number of ratees in the corresponding workgroup, calculating a workgroup inflation coefficient which provides a numeric indicator of how inflated the numeric workgroup performance ratings received from the workgroup rater are compared to a predefined workgroup normalization average, and calculating an inflation adjusted workgroup performance rating for each workgroup by multiplying each workgroup performance rating by the workgroup inflation coefficient. The workgroup inflation coefficient may be calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance ratings for the workgroups rated by the same rater.

The inflation coefficient may be calculated by I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the performance ratings received from the rater.

The method may further comprise calculating an inflation number which provides a numeric display of how inflated the one or more numeric performance ratings received from the rater are compared to the predefined normalization average, and displaying the calculated inflation number. The inflation number may be calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

Calculating, based on the one or more numeric performance ratings received from the rater, a performance score for each of the one or more performance elements may comprise calculating an average of the one or more numeric performance ratings for each of the one or more performance elements over a predetermined time period.

Receiving from a rater one or more numeric performance ratings for each of one or more performance elements for a ratee over a predetermined period of time may comprise receiving from a rater one or more interim numeric performance ratings over the predetermined time period and a final numeric performance rating at an end of the predetermined time period for each of one or more performance elements for a rate. Calculating, based on the one or more numeric performance ratings received from the rater, a performance score for each of the one or more performance elements may comprise calculating an average or a weighted average of the one or more interim numeric performance ratings and the final numeric performance rating for each of the one or more performance elements over a predetermined time period.

The method may further comprise calculating an overall performance score for each of the plurality of ratees by averaging the calculated performance score for each of the one or more performance elements for each of the plurality of ratees. The inflation coefficient may be calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

In addition to the method for human resource management, as described above, other aspects of the present invention are directed to corresponding systems and computer program products for human resource management.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic block diagram of a computer network in which embodiments of the present invention may operate.

FIG. 2 illustrates the basic rating element feedback process, in accordance with embodiments of the invention.

FIG. 3 illustrates the basic process for completing a rating element, in accordance with embodiments of the invention.

FIG. 4 illustrates an example workgroup structure, in accordance with embodiments of the invention.

FIG. 5 illustrates an example of how to calculate a ratee's non-inflation adjusted rating for a rating period, in accordance with embodiments of the invention.

FIG. 6 illustrates an example of how to calculate a rater inflation coefficient and an inflation number, in accordance with embodiments of the invention.

FIG. 7 illustrates an example of how the reviewer process can alter ratings, in accordance with embodiments of the invention.

FIG. 8 illustrates the workgroup performance rating process, in accordance with embodiments of the invention.

FIG. 9 illustrates an example of how to calculate a workgroup inflation coefficient and a calculated workgroup performance score, in accordance with embodiments of the invention.

FIG. 10 illustrates the ombudsman challenge process, in accordance with embodiments of the invention.

FIG. 11 illustrates the peer review process, in accordance with embodiments of the invention.

FIG. 12 illustrates a multiple rater scoring example, in accordance with embodiments of the invention.

FIG. 13 illustrates an example of various levels of supervisorgroups, in accordance with embodiments of the invention.

### DETAILED DESCRIPTION

Embodiments of the invention provide a system and method for evaluating personnel within a hierarchical organization by utilizing networked computer systems and programmed software. Embodiments of the invention provide accurate ratings of personnel and groups of personnel within an organization. These ratings are based on frequent feedback and are easy to compare. Embodiments of the invention also allow for effective comparisons of individuals from separate organizations. Additionally, embodiments of the invention permit users to see the objectives, tasks, or competencies of other individuals within the system. Finally, embodiments of the invention use peer feedback and an ombudsman challenge system to ensure accuracy and fairness within the system.

Embodiments of the invention provide a system of performance evaluation that is desirable because it addresses the problem of rater inflation without the negative outcomes associated with existing forced distribution methods. Additionally, embodiments of the invention provide better quality, more useful, and more accurate feedback to ratees, without burdening raters with the obligation to write long blocks of text to justify their ratings. Finally, embodiments of the invention allow rating related data to be broadly disseminated and shared between users of the system.

The system comprises an application server 10 running performance management software in accordance with embodiments of the invention. Server 10 is linked, using any suitable communication link, to a database 20 which houses relevant data for the application. The application server and database are linked to a distributed communication network 30. Any number of user client machines 41, 42, 43 can then connect to the server via the network. Communications network 30 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, client machines 41, 42, 43 and server 10 may be linked over any suitable communication network.

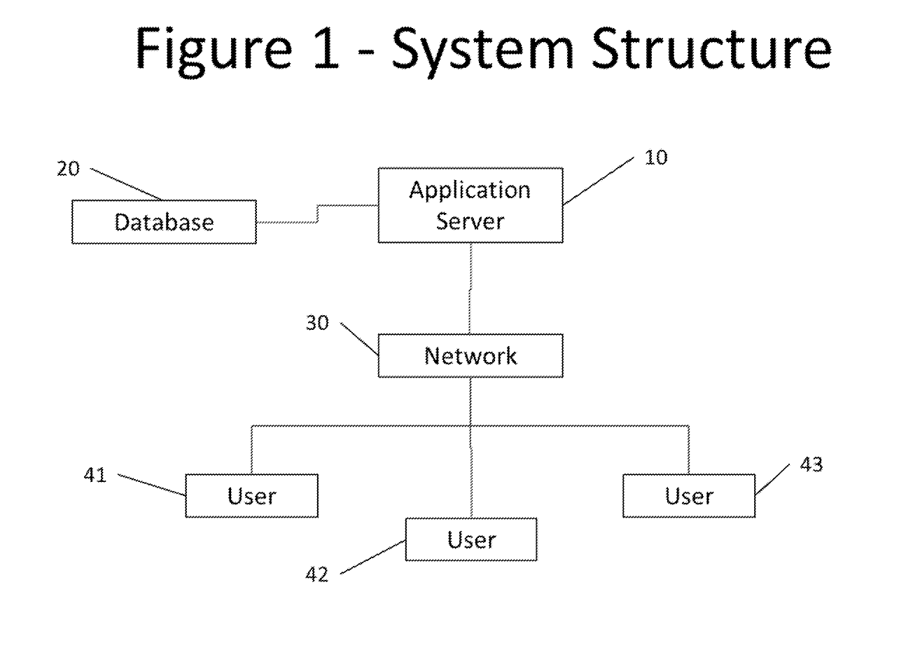

In addition to the client-server arrangement of FIG. 1, embodiments of the invention may operate in any client-server arrangement or in any networked arrangement in which resources that originate communications and resources that receive communications may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

The software itself comprises some or all of the following components:
1. A storage system for maintaining all user profiles for all users of the system, containing relevant user information and the ability to assign users to different roles.
2. Objectives, which are metric based goals to be attained by ratees.
3. Tasks, which are non-metric based goals to be attained by ratees.
4. Competencies, which are assessments of a ratee's aptitude in a certain area.
5. Development plans, which a rater can establish with a ratee for the purpose of improving the ratee's performance.
6. An internal messaging system.
7. A system to create and rate workgroups, which comprise multiple ratees.
8. A system to link Rating Elements (objectives, tasks, or competencies) with one another.
9. A system to grant monetary awards to certain ratees based on performance.
10. A notification system for alerting users to required tasks.
11. A system for generating reports.
12. An ability to modify the internal settings of the system, based on each users role.
13. An ombudsman challenge system that enables users to grieve certain results.
14. A peer survey system.

To operate the system, user profiles and credentials must typically first be established. These will, in most embodiments, be created by one or more administrators who operate the system on behalf of an organization. In other embodiments, users may create their own profiles. Creation of a user profile will generate an email notification to an individual's email account. That individual would then need to enter basic profile information and establish a password. Each user record will be linked to personally identifiable information (e.g., a social security number, etc.) or other unique identifying information so that duplicate records are not created over time. An individual, upon leaving one organization, may join another organization which also utilizes embodiments of the invention. Procedurally, the gaining organization would send a request through the system that would generate an email, or other electronic invitation, requesting that the individual join the gaining organization. The individual would then need to consent by accepting the electronic invitation. In such a case, the ratee's record would then follow them to the new organization. In this way, over time, extensive amounts of historical performance data will be compiled. At any time, either the individual or the organization could end the relationship by submitting an automated request through the system. In such a case, any outstanding or recently completed rating elements could be deleted by the individual, at the individual's request, by means of the individual submitting such an electronic request.

Administrators can create relationships within the system between ratees, supervisors, and raters. The role of a rater is to provide ratings and feedback to a ratee's rating elements. However, the rater need not have a supervisory relationship to the ratee. Supervisors, however, do have a supervisory relationship to the ratee, and must approve the ratee's rating elements, although the supervisor does not actually need to be the rater of any of the rating elements. Supervisors may also create relationships between ratees and raters by creating or approving rating elements. In one embodiment, the system would be limited to allow a ratee to have only one supervisor at the time, although other embodiments would allow multiple supervisors.

Administrators also assign workgroup raters, who rate the performance of workgroups. Administrators also have various other abilities within the system, including the ability to create and administer pay pools, set various definable settings, and any other system specific duties that are not appropriate for raters, ratees, or supervisors to handle. Administrators accomplish these things by using their access to protected web pages, which allow them to modify certain internal settings that other users do not have access to.

Users must typically then create an appropriate number of rating elements for each ratee. In some instances, the ratee will create an initial draft of the rating element, and the ratee's supervisor will approve or reject the draft. In other instances, the supervisor, a higher level supervisor, or an administrator could unilaterally approve and impose a rating element on a ratee. In either case, approved rating elements form the basis for ratings. Ultimately, rating elements are scored by means of numerical ratings. More than one rater can be assigned to each rating element. While virtually any numerical scale could be used, for purposes of this document, we will assume that the default rating scale is 1-5, where 1 is very low performance, 5 is very high performance, and 3 is satisfactory or meeting expectations. Also, rating elements can be assigned to groups, so that more than one ratee has the same rating element and receives the same feedback and ratings for that rating element. Another feature of rating elements is that they can be set to renew, so that, once complete, a new rating element with the same or similar parameters and duration would be initiated as soon as the first rating element was finished.

Objectives, one type of rating element, are specific and metric based goals that a ratee must achieve within a defined amount of time. Objectives follow a specific format in order to ease and speed their creation. The format is Verb-Metric-Object-Date. The “Verb” is an action verb. The “Metric” is a quantifiable amount of something to be achieved. The “Object” is the thing that the metric is modifying. Finally, “Date” is the specific due date for achievement of the goal. So, as an example, an objective could be “Sell 5 computers by Wednesday,” where “sell” is the verb, “5” is the metric, “computers” is the object, and “Wednesday” is the date (however, the date must ultimately be defined as a specifically identifiable date, e.g. Aug. 24, 2012.) Additional information can also be specified in a field called “Additional Information.” In another embodiment, the Metric could specify a range, so as to provide a goal that the ratee must stay above some level but below another level. In another embodiment, users could specify a Metric achievement level that corresponds with excellence, and users could also specify a level at which the ratee would be considered to have failed or to need improvement.

In one embodiment, all raters would have a “performance management compliance objective” automatically associated with their profile. This objective would be controlled by the system, not a human rater, and would provide positive feedback and a high rating to those raters who provide timely feedback to their ratees. On the other hand, it would provide poor feedback and low ratings to those raters who did not provide timely feedback to their ratees. In another embodiment, ratees with no currently active rating elements could also be penalized in the same way.

Tasks, another type of rating element, are non-metric based goals that a ratee must achieve within a defined amount of time. Since many work requirements are not susceptible to being reduced to metrics, tasks enable raters and ratees to define requirements in a broader, but still specific, way. Tasks are described within the system using a one-line “Headline” to describe the title of the task, as well as a “Narrative” body that contains all of the information required to understand the task.

Competencies, the final type of rating element, are assessments of a ratee's aptitude in a certain subject area, such as customer service or critical thinking. Competencies are assessed within a defined span of time. Competencies are described within the system using a one-line “Headline” to describe the title of the competency, as well as a competency “Narrative” body that contains all of the information required to understand the competency.

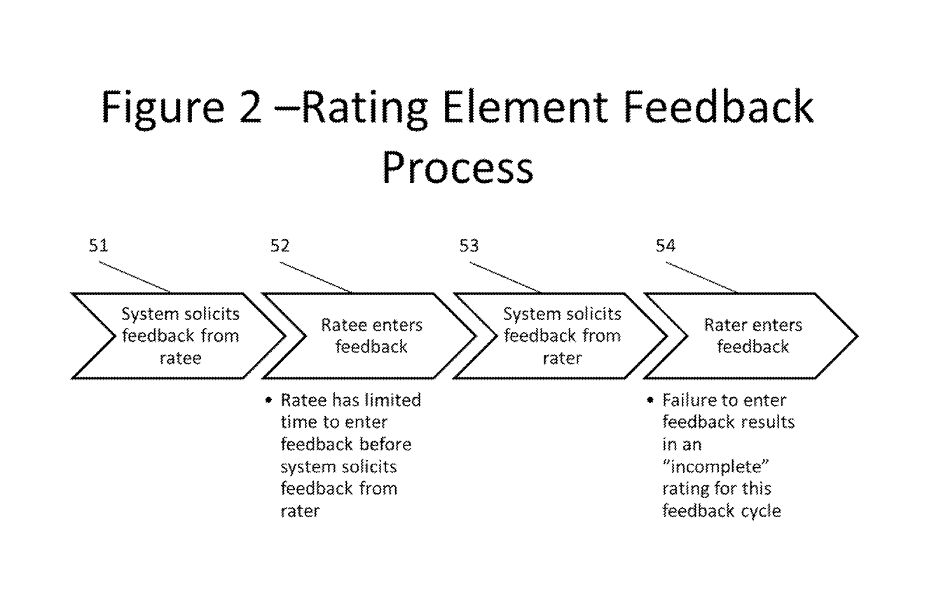

Rating elements typically must be assigned a due date by the rater during the approval process. Periodically during the rating period (e.g. daily, weekly, or at other intervals of time) the system will automatically generate and send an email or other electronic communication to each ratee (see FIG. 2.) In one embodiment, this communication will solicit narrative feedback 51 for each rating element from the ratee at the end of the periodic (daily, weekly, etc.) interval (although raters and ratees could input feedback into the system more frequently and save it for submission later.) It will also ask the ratee how he or she performed in comparison with the expectations established by the rating element (for example, possible choices being “exceeded expectations,” “met expectations,” or “needs improvement.”) In other embodiments, variations of these are possible. The ratee has a limited time to record his feedback in the system 52 before the rater receives a similar email 53 soliciting his own feedback. Once the rater receives the solicitation, the rater typically must then provide a numerical rating 54. In one embodiment, the rater would be required to provide narrative feedback to justify any rating above a predefined level or below a predefined level. However, the rater could simply adopt the ratee's justification if desired and if one had been provided.

The rater could also provide the ratee with a “shadow” rating for the period. A shadow rating is a rating that displays as one rating which only the rater and ratee are aware of, but displays as a different rating to other users and to the system for purposes of rating calculations. The purpose of the shadow rating is to warn the ratee about poor performance without actually penalizing the ratee. In some embodiments, if the rater desires, the rater could change any rating he has made within a limited period of time after providing the rating.

If the rater does not provide feedback within a limited amount of time, the ratee receives an “incomplete” for the feedback period and is notified that the incomplete will be made permanent if a rating is not entered within a limited amount of time. In one embodiment, for scoring purposes, an incomplete would count as less than a “meets expectations” or average rating, so as to provide an incentive to avoid such ratings. If the incomplete is not rectified within a limited amount of time, it could then only be changed by means of a formal ombudsman complaint within the system. In another embodiment, an incomplete would not penalize the ratee, but instead would penalize the rater by means of automatically generated negative feedback which would adversely impact the rater's own rating.

Rating elements can be modified while active, but only in limited ways. The main objective information (verb-object-metric) and the main task or competency narrative information could not be changed while the rating element is active. However, the due date may be changeable, but only to allow more time for completion. Raters could be added or subtracted from the rating element to allow for personnel changes over time. Other minor changes could be made to the rating element if desired.

Rating elements can be cancelled at the request of the ratee, but only with the consent of the supervisor. If the supervisor wishes to cancel the rating element, no ratee consent is required. If the rating element is cancelled, the system would initiate the sequence for completing the rating element.

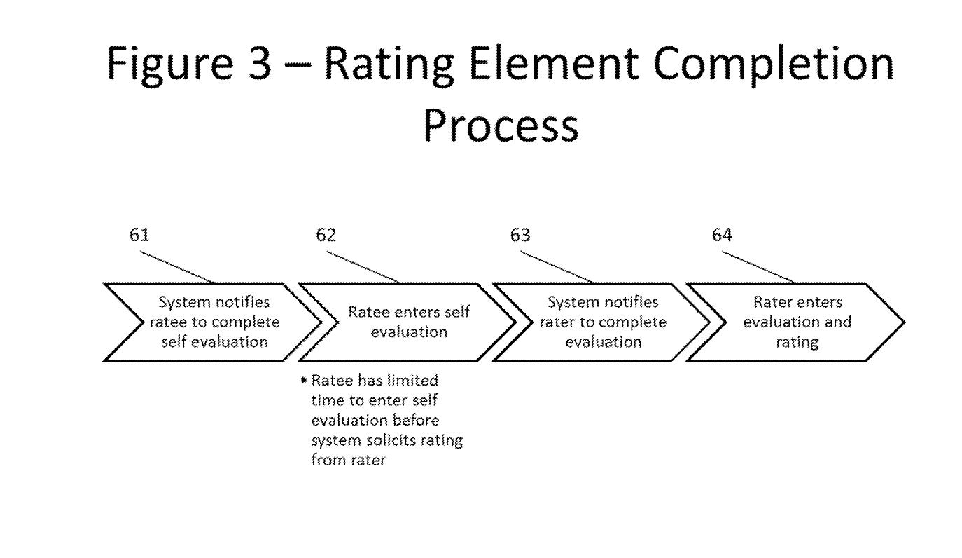

If a rating element requires completion (by being cancelled, reaching completion date, or by the supervisor or ratee notifying the system that it is complete ahead of schedule), then the completion sequence starts, which results in a final feedback rating (see FIG. 3.) The ratee is notified by email or other electronic communication to complete a self-evaluation 61. The ratee has limited amount of time to complete this (e.g. 10 days), but, in some embodiments, the rater can extend that time if desired. If the ratee runs out of time and no extension is given, the evaluation is then transferred to the rater. Normally the self-evaluation 62 does not allow the ratee to numerically rate himself, but this setting could be changed based on administrator preference. It does allow the ratee to input the final, actual metric value (for objectives), and to input narrative comments. Ratee can also visually highlight important feedback comments from earlier in the rating cycle in order to bring them to the attention of the rater. The ratee can also attach other digital files if desired.

Once the ratee has input the self evaluation or time has run out, the ratee can transfer the evaluation to the rater(s) for action. The rater(s) would then receive an electronic notification to this effect 63. For a rating element with multiple raters, this process happens separately for each rater. Upon logging in, the rater sees the ratee's basic information (name, title, etc.), information connected with the rating element, the self evaluation, and all past weekly feedback ratings. The rater would then input the results of how the ratee performed versus the metric (for objectives only) and provide a final feedback rating for the rating element 64. The rater can provide narrative explanation if desired, but if not, the ratee's narrative alone would be displayed to anyone viewing the rating element in the future. Additionally, in one possible embodiment, the system could be set up to allow an advisor, such as an HR department, to review all narratives before they could be finalized within the system.

A factual disagreement between the rater and ratee's assessment of a metric assessed as part of an objective would be flagged, and the system would ask the rater about the discrepancy. If the rater did not change his metric input, then an electronic communication or email would be generated for the ratee, alerting him of the discrepancy. The ratee would have the option to simply annotate disagreement within the system, or, alternatively, the ratee could initiate a formal complaint in the system using the ombudsman.

Within the system, there is an internal messaging system that enables users to send short messages to other users quickly and easily. Messaging prompts could appear on each page of the site, and would be contextually sensitive to the likely recipient of any message. For instance, if a ratee looks at a page with an objective on it, the messaging box would default to sending a message to the rater of that objective. If a user does send a message, the message would be transmitted to the recipient as both an email and as a message within the internal messaging system. The recipient would see the message upon logging in to the system, and could reply at that time as well.

During the rating period, ratees can see where they stand versus other ratees by checking a page that would display data regarding ratings provided during that rating period. This feature would average all ratings provided by a rater to each ratee, by date, which we will call the aggregated current data. The data would be displayed on a page with a separate chart or data display for each rater who is rating the ratee during the current rating period. Within each chart or data display, the aggregated current data will be displayed for each ratee rated by that rater. In one embodiment, all names of the ratees are shown on this chart or data display. In another embodiment, the names of the other ratees would be anonymized, and the only ratee data that would not be anonymized would be that of the ratee who had requested the data.

In addition to rating elements, ratees and/or raters can create development plans for a ratee. These development plans operate in a similar way to rating elements. However, they are intended to provide a path to improvement for the ratee (e.g., by giving the ratee goals to accomplish in order to improve the ratee's proficiency). The system could suggest the use of a development plan to the rater if a rater's ratee had received feedback on rating elements that was below a certain level of achievement. Development plans have a due date, but no periodic feedback. On the due date, the ratee provides a self evaluation regarding his own performance and then submits the plan to the rater. The rater must then decide whether the ratee met the criteria established within the plan, or not. The rater can also provide narrative feedback to the ratee. The development plan is not visible to anyone in the system besides the rater and ratee, and the development plan does not in any way impact any end of year rating calculations.

The system provides a way for users to search for and see other users, their rating elements, and their performance results. Settings for who can see whom, as well as what specifically can be seen, can be modified and would be based on the role of the user and which rating elements are set as “private.” In one embodiment, users would be able to see other users within or outside of their workgroup through a search function or with a hierarchical tree view of all visible users. In this embodiment, ratees may or may not be able to see the scores that other ratees have received, based on the privacy settings enabled by the administrator. In another embodiment, raters can see all of their ratees, along with their current and past rating data. In another embodiment, a user (e.g. a talent recruiter) could search using a web based search tool for other users (e.g., unemployed workers) in a defined area based on their ratings and other defined criteria. In another embodiment, a user (e.g., a hiring manager) could view performance data on a web page in order to assess another user's performance and work history (e.g., a job candidate.) Numerous other uses for this capability are possible with this system.

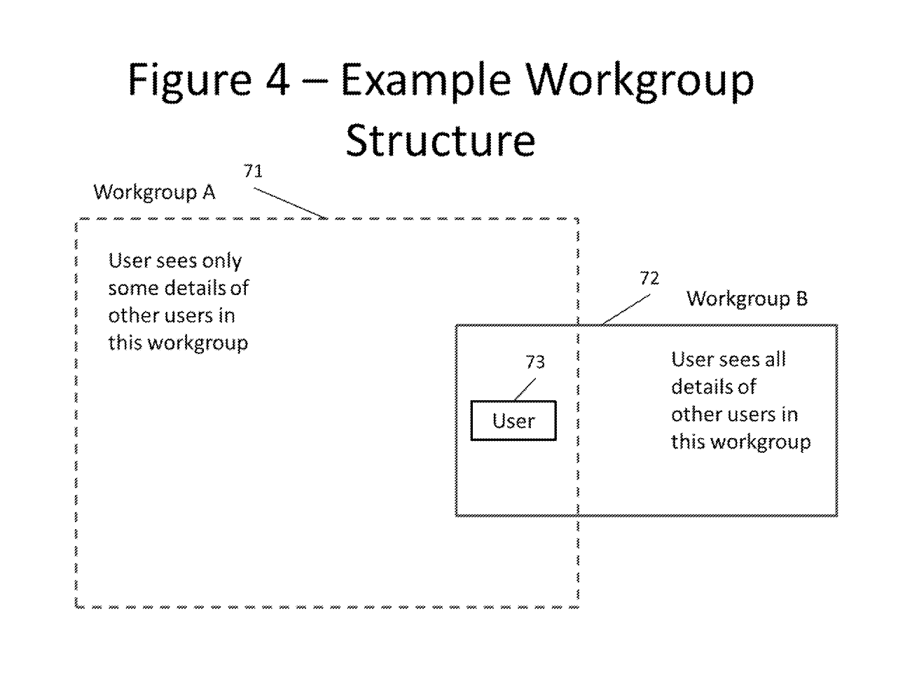

Users of the system can be assigned to groups known as “workgroups.” Workgroups can be used for determining which other users a user can see and what they can see about those users (see FIG. 4.) For instance, users 73 in a local workgroup 72 may be able to see all details of each other's rating elements, while the users of a broader, overlapping workgroup 71 may only be able to see a more limited set of details. Another function of the workgroup is for rating purposes. Workgroups themselves can receive ratings based on performance, so that a high performing workgroup may be rated more highly than an average workgroup. Membership in a more highly performing workgroup would boost the user's rating, while membership in a lower performing group would lower it. For example, a ratee may be the most highly rated in her workgroup, but if her workgroups' ratings are low, then her overall performance rank amongst all ratees would be more towards the middle of the distribution. Conversely, a ratee who is the most poorly rated by his raters could also find his place in the overall distribution more towards the middle, if he belonged to the highest rated workgroups. The coefficient used to determine the modification of the user's rating would be based on an average rating of all the workgroups to which the user belonged. For example, the average of all of the workgroup ratings of all of the workgroups to which the user belonged could be multiplied by ⅓. That result could then be added to the ratee's inflation adjusted rating element score multiplied by ⅔. Thus, in this scenario, the average of the workgroup ratings is weighted by ⅓, while the inflation adjusted rating element score is weighted by ⅔. The result of these calculations yields a single number that is highly correlated with the ratee's actual performance. In other embodiments, the average would instead be a weighted average, for instance weighting certain workgroups more heavily based on definable criteria, such as who the raters were and which workgroups they belonged to, how many rating elements they evaluated, and the length of time that the rating elements lasted. For example, similar to the above example, the weighted average of all of the workgroup ratings of all of the workgroups to which the user belonged could be multiplied by ⅓ (we will call this result “k”). The ratee's inflation adjusted rating element score could also be multiplied by ⅔ (we will call this result “1”). In this example, “1” could be further modified by multiplying it by a weighted average of all of the workgroup ratings that the rater belonged to. This would have the effect of weighting the opinions of raters who work in highly performing workgroups more highly than raters who work in other workgroups. This modified “1” could then be added to “k,” as in the example above. An alternative way to modify “1” could be to multiply it by the number of days from the approval of the rating element until its completion date. This would weight longstanding rating elements more heavily than briefer rating elements.

Another feature of the system is the ability for raters and administrators to create templates of rating elements. These templates are stored on the server and can be used to quickly assign new rating elements to ratees without going through the entire rating element creation process.

Another capability enables rating elements to be linked to one another in hierarchical relationships. For instance, objective A can be subordinate to objective B, which can in turn be subordinate to objective C. In this way, ratings elements can have a logical relationship to one another within the organizational structure.

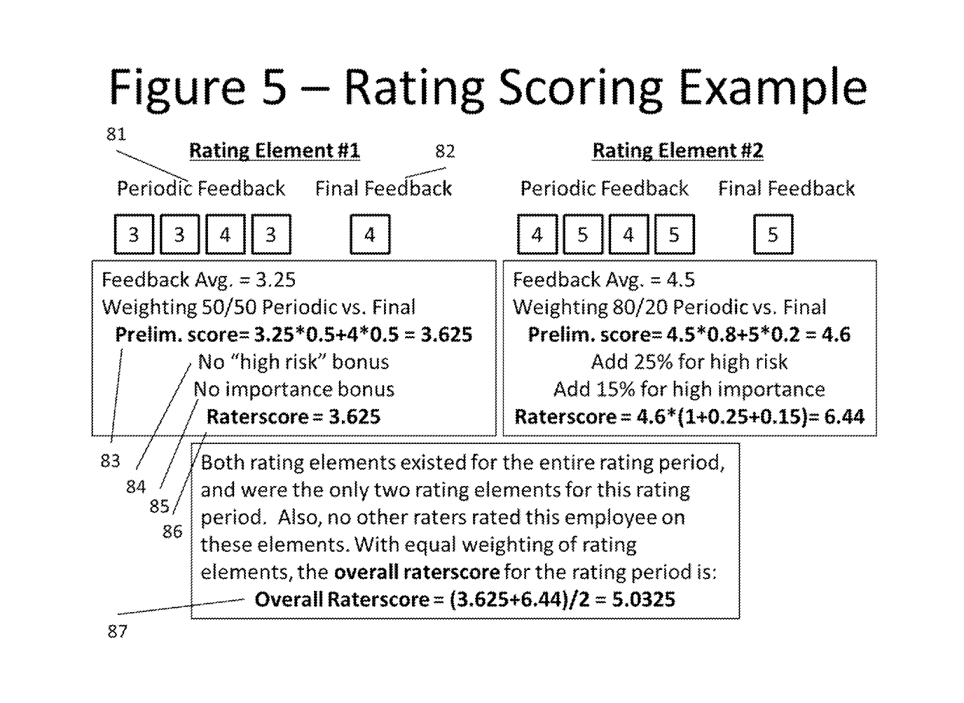

Rating element final scores are calculated based on averaging an average of the periodic feedback ratings 81 with the final feedback score 82 (plus any additional adjustments, such as based on high risk or importance, as discussed further below) (see FIG. 5). This final score is termed a preliminary raterscore 83. A preliminary raterscore is the score calculated for a single rating element for a single ratee based on the feedback from a single rater, based on all numerical feedback provided, as well as any weighting of the periodic feedback versus the final feedback based on system settings. The average periodic feedback score is an average of all of the periodic ratings given for that rating element. The average feedback score and the final feedback rating could be weighted based on settings established for the rating element 83 (e.g. 80% for the periodic feedback and 20% for the final rating.) In another embodiment, weighting would not be possible, and all feedback scores, including the final feedback score, would be added together and an average taken. Additionally, when the rating element was created, the rater could be given an opportunity to designate the rating element as being “high risk” or not. This high risk designation would provide a bonus (e.g. 25% increase in rating score) if the ratee achieved a rating at or above a defined level 84. In another embodiment, this bonus amount would be rater definable. This option is intended to reward ratees who undertake objectives that are risky. In other embodiments, other, user or administrator definable criteria could be added to modify a preliminary raterscore positively or negatively. In another embodiment, no modification of the preliminary raterscore with additional adjustments such as “high risk” or “importance” would be possible.

Administrators can designate rating periods for assessment of groups of ratees (such as yearly performance periods for employees.) Within these periods, each ratee will likely have completed numerous rating elements. In some embodiments, in order to calculate the ratee's score for the rating period, each rating element of the ratee is weighted based on its duration during the rating period (e.g. if the ratee had four objectives in a year, and two lasted 9 months and two lasted 3 months, then the first objectives would be weighted 37.5% each and the other two 12.5% each.) However, in other embodiments, the duration of the rating element would have no effect on the score. In some embodiments, each rating element has an “importance field” that the rater selects (e.g. high, medium, and low importance.) The level of importance of each rating element would modify the weighted rating element, such that highly important rating elements would receive additional weight over less important rating elements 85. Once the preliminary raterscore has been weighted using any or all of the above criteria, the result is called the raterscore 86.

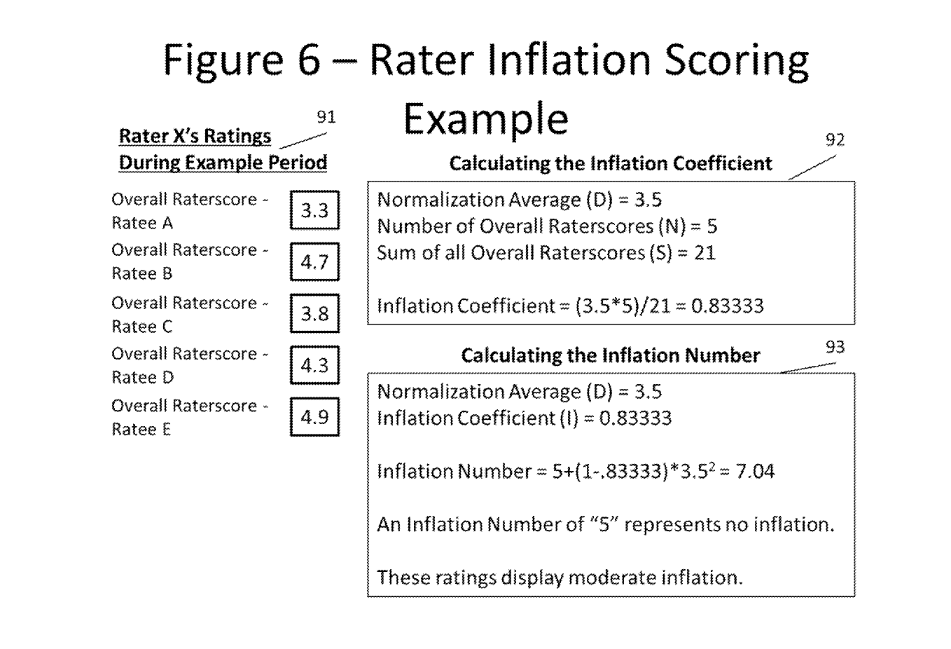

Once raterscores are calculated for the period, the system will then calculate how inflated the rater's ratings were (see FIG. 6.) All raterscores for the given rater during the given rating period 91 would be put into a formula in order to find the “inflation coefficient.” In one embodiment, all raterscores for the period are used directly in the formula. In another preferred embodiment, the raterscores of each rater for each ratee would be averaged into an overall raterscore 87 prior to being input into the formula (e.g. if rater X evaluated ratee B on two rating elements, the raterscores of those two elements could be averaged prior to the formula being run.) The formula for calculating an inflation coefficient 92 is I=(D*N)/S, where “I” is the inflation coefficient, D is the normalization average (an arbitrarily determined constant that all rating results will be normed to, e.g., a rating of 3 on a 1-5 scale), N is the number of raterscores given by the rater during the period (if the inflation coefficient is being calculated using the raterscores) or the number of overall raterscores calculated for the rater during the period (if the inflation coefficient is being calculated using the overall raterscores), and S is the sum of all raterscores given by the rater during the period (if the inflation coefficient is being calculated using the raterscores) or the sum of the overall raterscores calculated for the rater during the period (if the inflation coefficient is being calculated using the overall raterscores). Each raterscore can then be multiplied by the rater's inflation coefficient for that rating period, which produces an inflation adjusted raterscore.

The inflation coefficient can also be used to produce an “inflation number” (see FIG. 6.) The inflation number can be displayed next to the ratee's ratings for the period whenever the rating is displayed within the system. The inflation number is intended to provide an easy way for the viewer to evaluate how meaningful a rating is. For instance, raters often give a large number of high ratings to their ratees. In such an instance, the ratings would be accompanied by a high inflation number, which would indicate to the viewer that the rater frequently gave high ratings. The inflation number could be calculated in a variety of ways. In one embodiment, it would be calculated in the following way: F=X+(1−I)*D², where F is the inflation number, X is any number whose value is indicative of no inflation, I is the inflation coefficient, and D is the normalization average 93. There are virtually unlimited other ways to calculate such a number. In other embodiments, the inflation number for the rating period could be averaged with past inflation numbers for that rater, in order to create a number that takes past ratings into account.

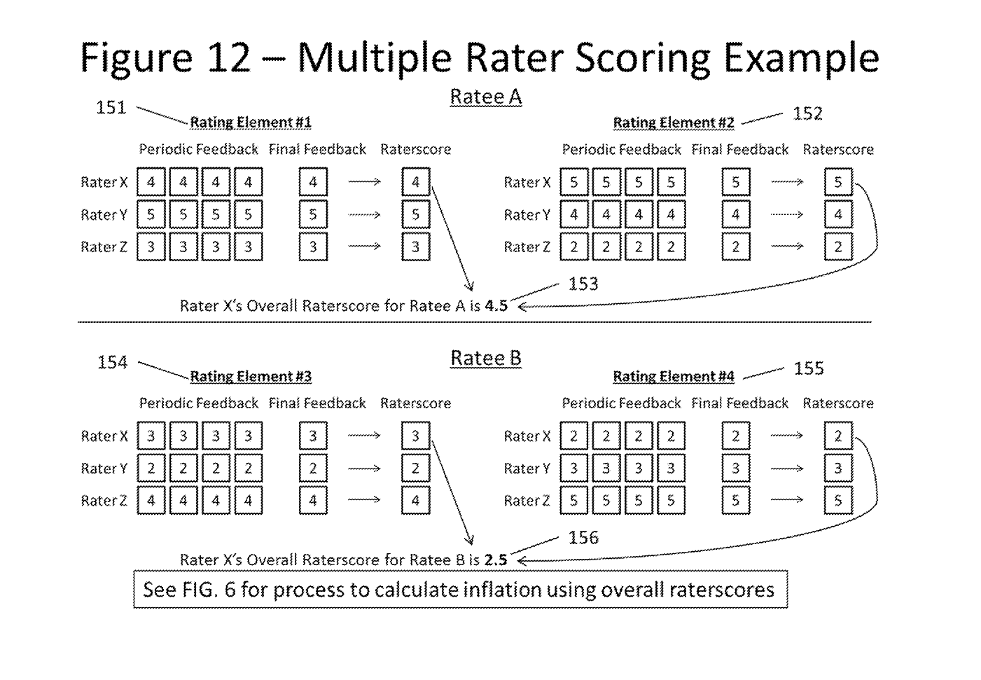

In cases where multiple raters rated a rating element or elements, the raterscore, inflation coefficient, inflation number, and inflation adjusted raterscore would all be calculated separately for each rater, as if that rater were the only rater who was rating the ratee (see FIG. 12 for overview of multiple rater, multiple ratee, and multiple rating element scenarios.) Once the separate calculations were accomplished, the results of each rater in each of the four categories above could be averaged with a regular or weighted average to form a composite rating by category. For instance, “ratee A” is rated by “rater X” and “rater Y.” These raters both rated all of “ratee A's” rating elements, along with several other ratees. “Rater X” would have his raterscore of “ratee A”, his inflation coefficient, his inflation number, and any inflation adjusted raterscores calculated based off of only the ratings that he gave to “ratee A” and the other ratees that he rated, not based on any ratings of “rater Y.” Once the raterscore, inflation coefficient, inflation number, and inflation adjusted raterscore were calculated independently for each rater, then supposing that “rater X” and “rater Y” were to receive equal weight within “ratee A's” evaluation, and supposing “rater X” had an inflation number of 5 and “rater Y” had an inflation number of 7, then the inflation number appended to “ratee A's” rating would be an average of the two inflation numbers, resulting in a composite inflation number of 6.

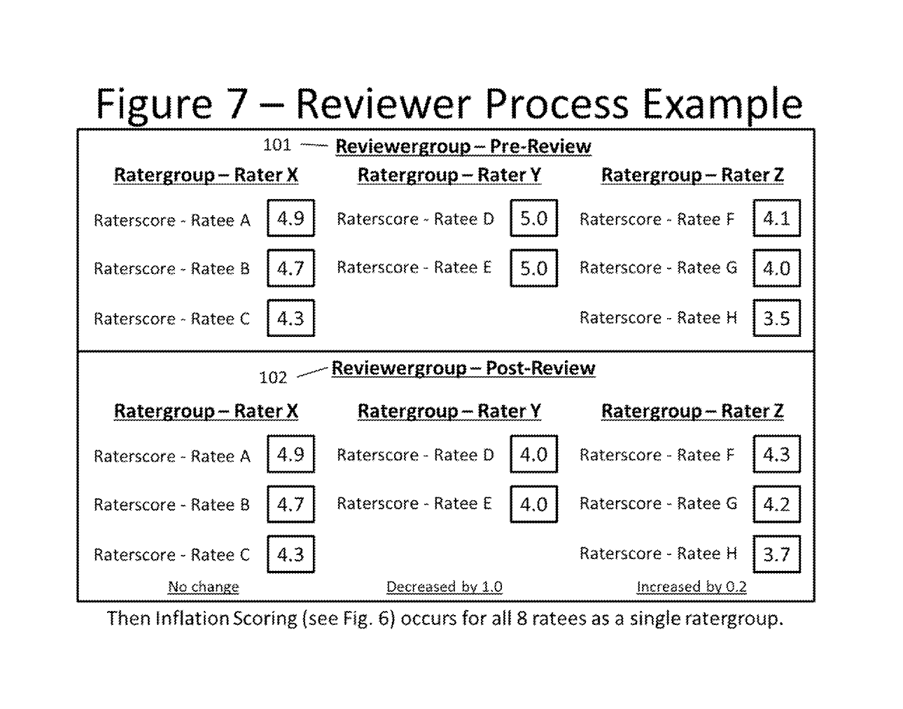

The above system for assessing rater inflation works well for raters who rate a large number of ratees. However, in one possible embodiment, an additional step is required in instances where raters rate very few ratees. In instances where the number of ratees that a rater rates is below a certain defined threshold, administrators must group several ratergroups (a ratergroup is all the ratees rated by a certain rater) together into a reviewergroup 101, so that they will be assessed together (see FIG. 7.) The administrator must also select a reviewer who will determine if any of the ratergroups as a whole are inflated relative to the other ratergroups. This will be done by means of the reviewer operating controls on a webpage to adjust all of the ratings in a ratergroup up or down. Ratergroups would be adjusted as a unit, relative to other ratergroups, so any mathematical operation applied to one rating in the ratergroup would be applied to all other ratings within the ratergroup. Once the reviewer is satisfied with the outcome 102, the system will treat the reviewergroup as a ratergroup for purposes of determining the inflation coefficient and the inflation number. In other embodiments, the grouping of the ratergroups and the selection of the reviewer can be handled automatically by the system using random selection criteria or other definable criteria.

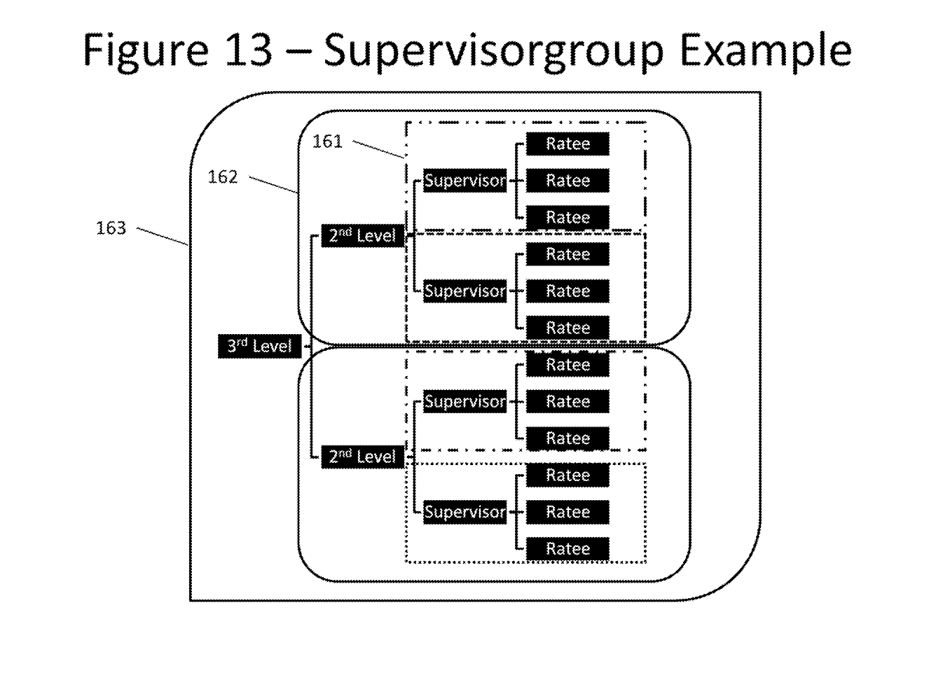

In another preferred embodiment, the system would automatically group all ratees under each supervisor, along with the supervisor himself, into a supervisorgroup (see FIG. 13.) These groupings would apply to all users and would overlap, such that a supervisorgroup 162 headed by a 2^{nd} level supervisor would include the supervisorgroups 161 for each of his subordinate supervisors, while a supervisorgroup 163 headed by a 3^{rd} level supervisor would include the supervisorgroups 162, 161 of both the 1^{st} and 2^{nd} level supervisors below him. At the end of the rating period, or, alternatively, on a more frequent basis, every supervisor would rate each of the supervisorgroups subordinate to him, although, in a preferred embodiment, supervisors would only rate supervisorgroups headed by their direct subordinates. The ratings given would be based on the performance of the group as a whole. This supervisorgroup rating process would occur in the same way as the workgroup rating process, as described below. However, in some embodiments, there would be no proposal and review period, as specified in the workgroup rating process, and instead the ratings would become effective immediately. The ratings provided during a rating period by a supervisor to a subordinate supervisorgroup could be averaged using a regular or weighted average. In any case, the single rating or averaged ratings given by the supervisor to the supervisorgroup for the rating period is the supervisorgroupscore for that rating period. All supervisorgroupscores given by a rater during the rating period could then be adjusted for inflation using the same procedures described for workgroup performance ratings in the paragraphs below. Each ratee in a hierarchical organization may thus receive multiple inflation adjusted supervisorgroupscores for the rating period. These ratings could then be multiplied together, averaged, or subjected to a weighted averaging method in order to create a calculated supervisorgroup performance score for each ratee. In one embodiment, the system could average all of the ratee's supervisorgroupscores for the rating period to calculate the “calculated supervisorgroup performance score”. Another method of calculating the calculated supervisorgroup performance score could limit which supervisorgroupscores were used in the average (e.g., only the 2^{nd} level and 3^{rd} level supervisorgroupscores might be used, but not higher level scores.) Another method of calculating could dampen the effect of supervisorgroupscores based on the distance of the rater from the ratee. In such an embodiment, each supervisorgroupscore given by a supervisor could be adjusted with the formula A=(N+S/D)/(N+1), where A is the adjusted supervisorgroupscore, N is the dampening coefficient, S is the given supervisorgroupscore, and D is the normalization average. The larger the N value, the more that the value of A approaches 1. As an example, 2^{nd} level supervisorgroupscores could utilize an N of 2, 3^{rd} level supervisorgroupscores could be adjusted using an N of 4, 4^{th} level supervisorgroupscores could be adjusted using an N of 6, etc. This would have the effect of limiting the impact of ratings given by supervisors who were far removed from the ratee. Varying values of N could be used in order to obtain the proper level of dampening desired. All of the adjusted supervisorgroupscores for the ratee could then be multiplied together to obtain the calculated supervisorgroup performance score.

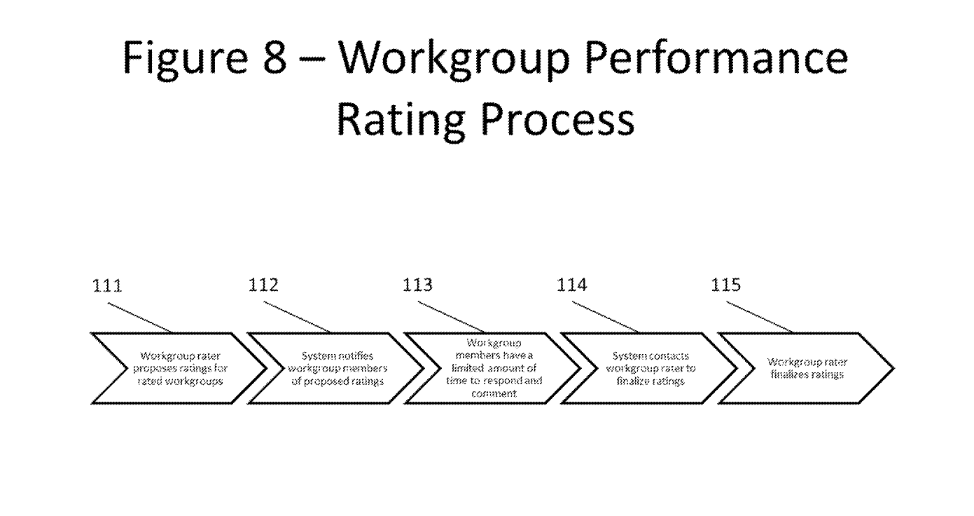

As suggested above, supervisorgroups are essentially a variation of a broader “workgroup” concept. Workgroups are groups of more than one individual within an organization, which can be rated as a unit in order to account for differences in the average quality of various groups within an organization. The worst worker in a group of high performers may still be better than the best performer in a group of low performers. Each workgroup would have at least one workgroup rater who would rate the workgroup on a periodic basis (e.g. quarterly, biannually, annually, etc.) This “workgroup performance rating” would be based on the workgroup's overall performance, as assessed by the rater. In the preferred embodiment, each workgroup rater would rate the workgroup only once, at the end of the rating period. In other embodiments, the workgroup rater could rate the workgroup multiple times throughout the period, and these ratings could then be averaged or subjected to a weighted average. These ratings would become proposed ratings by the workgroup rater at the end of the period 111 (see FIG. 8.) In some embodiments, the workgroup rater could be provided the opportunity or required to provide a narrative explanation regarding his rationale for his rating. The workgroup rater must rate a minimum number of workgroups (this number must be greater than 1.) All proposed ratings for the time period would be listed together, such as on a webpage or email. Members of those workgroups would then receive electronic notification through the system of the proposed ratings 112. The members of the workgroup would then have a specified number of days to respond and comment to the workgroup rater regarding the proposed rating and to any attached narrative explanation provided by the workgroup rater 113. Responses would be routed through the internal messaging system, except that the system could be designed with the option to strip the sender's name in order to preserve anonymity. Once the comment period elapsed, the system would query the workgroup rater regarding the ratings 114. The workgroup rater would then finalize the workgroup performance ratings for the period 115. In some embodiments, workgroups could be rated by multiple raters, whose calculated workgroup performance scores (described in the next paragraph) could be averaged together using a regular or weighted average. In other possible embodiments, the workgroup rater(s) would directly finalize their ratings without a proposal, review, and comment period.

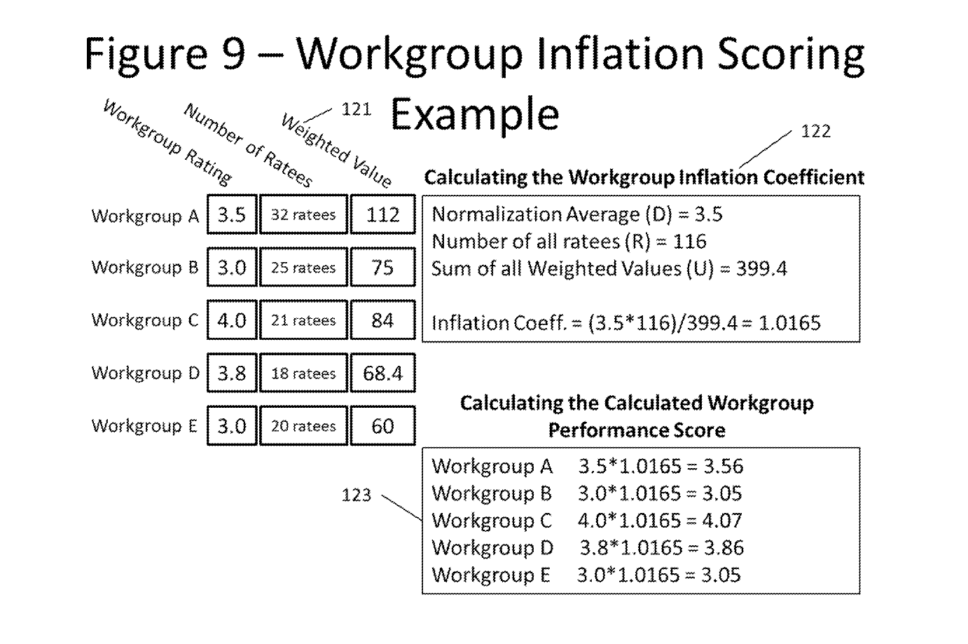

Once the workgroup performance ratings are finalized by the rater, the system would then adjust those ratings to account for rater inflation using the formula W=(D*R)/U, where W is the workgroup inflation coefficient, D is the normalization average, R is the number of all ratees in the rated workgroups rated by a given rater, and U is the sum of all of the rated workgroups' weighted values for the workgroups rated by the same rater 122 (see FIG. 9.) Each workgroup's weighted value is computed by multiplying the workgroup's performance rating by the number of personnel in the workgroup 121 (so if the workgroup performance rating was 5, and there were 10 people in the workgroup, the workgroup weighted value would be 50.) Once the workgroup inflation coefficient is known, the workgroup performance rating would be multiplied by the workgroup inflation coefficient to produce the calculated workgroup performance score 123. The calculated workgroup performance score could be displayed along with ratee's rating and the ratee's inflation number whenever rating data is displayed within the system.

Once this rating data is acquired, the system can use the data in numerous ways. For instance, the system could multiply an average of all of the ratee's inflation adjusted raterscores by an average of the calculated workgroup performance scores of all the workgroups to which the ratee belongs. The result would be a ratee's “final performance number” for the period. This number allows for simple, direct comparison of ratees' performance. In other embodiments, the weight of the calculated workgroup performance score in this average could be increased or decreased based on system settings. In another embodiment, the final performance number could be obtained by multiplying an average of all of the ratee's inflation adjusted raterscores by the ratee's calculated supervisorgroup performance score. Regardless of the method used, by reducing all performance data to one number, ratees can be sorted into percentiles.

One use of rating data is to enable the use of bonus systems or salary rewards tied to performance outcomes. In one embodiment, bonus results would be calculated based on a function Y=X^{z} ln(2), where Y is the amount of shares that a ratee would receive through the bonus process, X is the ratee's percentile rank (0.01 through 0.99), and Z is an integer that the administrator would select in order to vary the steepness of the bonus curve. Each ratee would thus be awarded some amount of shares. For the entire bonus pool, the total number of shares of all participants in the pool would be added together to create a sum total of shares in the bonus pool. The bonus pool administrator could then allocate a set amount of money to the pool. That amount of money would be divided by the total number of shares, which would yield the value of a single share. Ratees would then receive appropriate bonus compensation based on their number of shares. In another embodiment, bonus shares could be replaced with salary increase shares, and the same system could be used to award salary increases based on performance. In other embodiments, other formulae could be used for the curve which would produce a different result, such as Y=X^{Z} ln(2)|1, or Y=X|C, where C is an administrator definable constant. Additionally, within the system, administrators could set a minimum or maximum bonus or salary amount to be awarded, could set an absolute rating cutoff (below which no bonus or salary increase would be awarded), could set a percentile cutoff (below which no bonus or salary increase would be awarded), could limit or prorate bonuses or salary increases based on tenure, or could exclude a ratee from consideration altogether.

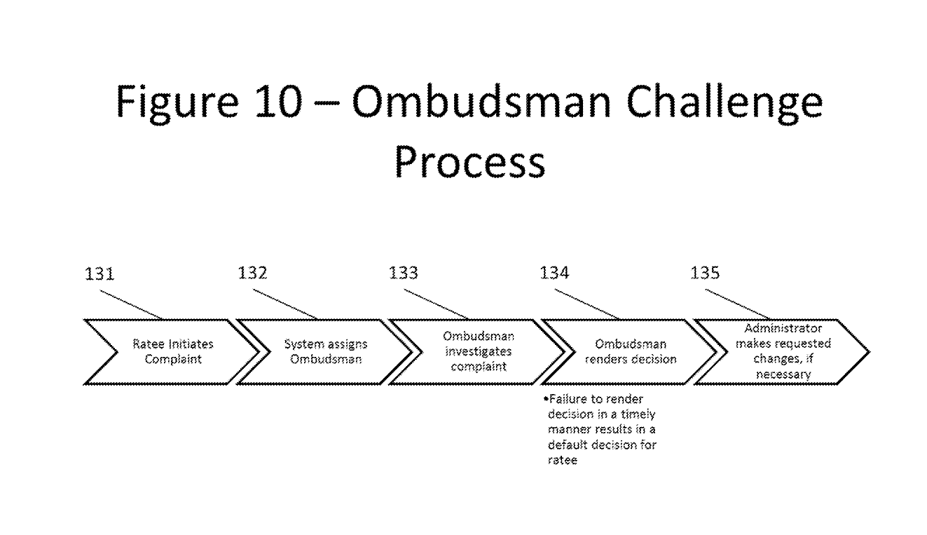

In order to provide an avenue for redress of grievances, an “ombudsman challenge system” would allow ratees to register a dispute and seek reparation. Any organization using this system could be required to identify at least two users within that organization as ombudsmen. An ombudsman would be responsible for resolving any complaints that he or she receives through the system. Users would have a limited number of days from the precipitating incident occurring to initiate a complaint with their ombudsman (see FIG. 10.) Users will initiate a complaint by filling out an online form that references the specific issue being grieved 131. Once the complaint is submitted, the system would transmit it to a randomly selected ombudsman within the organization 132 (in other embodiments, the ombudsman could be selected on the basis of how many complaints he is working, or other selectable criteria.) This ombudsman would then have a limited amount of time to investigate and make a decision regarding whether to sustain or deny the complaint 133. The system could provide the ombudsman with a checklist of advice or things to remember when conducting the investigation. In one embodiment, if no decision is made within the defined timeline, the complaint would automatically be decided in the complainant's favor. If a decision is made within the timeline, the ombudsman would specify his decision and the remedy 134. The results of that decision would then be viewable in the system, although which users could view it could be limited by the user's permission level. The administrator would then be required to make the ombudsman's requested changes within the system 135. In other embodiments, the ombudsman could directly make the changes within the system.

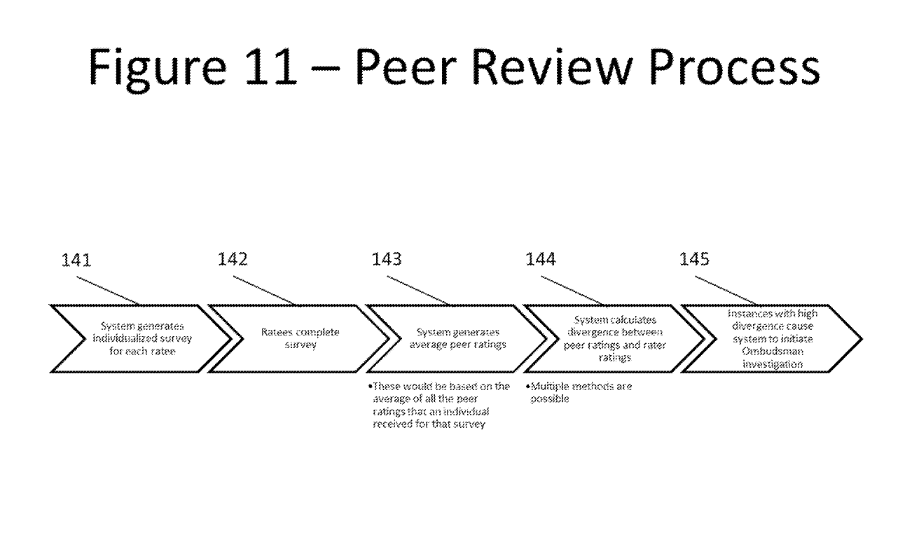

Another method of limiting abuse within the system would be through the use of automated peer surveys. At the end of each rating period, an automated survey would be generated by the system 141 (see FIG. 11.) Ratees will be notified to log in and complete the survey. In the survey, ratees would provide overall performance ratings for every other ratee who is rated by their rater 142 (e.g., if “rater X” rated “ratee A” and 5 others, then “ratee A” would evaluate the 5 other ratees on the survey.) Once all peer review data was collected, the data could then be adjusted for inflation using the same methodology used to create inflation adjusted raterscores mentioned above. These average adjusted peer ratings may be averaged using a regular or weighted average, comprising some or all of the peer ratings 143 (for instance, in some embodiments, the highest and lowest ratings could be excluded from consideration.) These composite ratings could then be compared to the rater's inflation adjusted raterscore of the ratee 144. In one embodiment, ratees could be rank ordered by both average peer rating and by inflation adjusted raterscore. The divergence between the two rank ordered lists could be calculated by subtracting the ratee's position on one list from the position on another list, and then taking the absolute value of that number (so if a ratee was number 2 in peer eval rank, and number 4 in inflation adjusted raterscore rank, then the divergence between the two lists would be the absolute value of 2 minus 4, which equals 2.) This divergence score would be divided by the total possible divergence (which is the absolute value of the top rank minus the bottom rank) to establish a divergence percentage. If a ratee's divergence percentage was above a certain established level defined within the system, then the system would initiate an automatic ombudsman investigation to look into the divergence issue and determine if the rating should be sustained or invalidated 145. In another embodiment, divergence could be assessed by taking the absolute value of the difference between the composite average adjusted peer rating and the composite inflation adjusted raterscore for each ratee. If a ratee's divergence was above a certain defined level, then an automatic ombudsman investigation would be initiated within the system. In some embodiments, any automatic ombudsman investigations must be completed before the system would allow any bonus pool or salary pool results to be generated. If the ombudsman did determine that the divergence was due to an inappropriate rating, then the ombudsman could invalidate the rating or create a new inflation coefficient for the rating.

The system will have the ability to display reports based on user queries. Users will be able to create reports to view a variety of data, such as results of bonus pools or lists of rating elements.

Finally, the system allows users to be awarded “badges” within the system based on performance. The system would award the badge and associate it with the user's profile if certain criteria were met. For instance, a ratee who received the highest possible score on all of her rating elements might receive a “Perfect Score” badge. Alternatively, a user who completed an objective in less time than originally assigned might receive a “Fast Worker” badge. This system would be designed to motivate and encourage users toward excellence.

In one embodiment of the invention, a system for human resource comprises a processor configured for: receiving from a rater one or more numeric performance ratings for each of one or more performance elements for each of a plurality of ratees over a predetermined period of time; calculating, based on the one or more numeric performance ratings received from the rater, a performance score for each of the one or more performance elements for each of the plurality of ratees over the predetermined time period; calculating an inflation coefficient which provides a numeric indicator of how inflated the one or more numeric performance ratings received from the rater are compared to a predefined normalization average; calculating an inflation adjusted performance score for each of the one or more performance elements for each of the plurality of ratees by multiplying each of the one or more performance elements for each of the plurality of ratees by the inflation coefficient; and displaying the inflation adjusted performance score for each of the one or more performance elements for each of the plurality of ratees.

The inflation coefficient may be calculated by I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the one or more performance ratings received from the rater.

The processor may further be configured for calculating an inflation number which provides a numeric display of how inflated the one or more numeric performance ratings received from the rater are compared to the predefined normalization average, and displaying the calculated inflation number. The inflation number may be calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

Calculating, based on the one or more numeric performance ratings received from the rater, a performance score for each of the one or more performance elements may comprise calculating an average of the one or more numeric performance ratings for each of the one or more performance elements over a predetermined time period.

Receiving from a rater one or more numeric performance ratings for each of one or more performance elements for a ratee over a predetermined period of time may comprise receiving from a rater one or more interim numeric performance ratings over the predetermined time period and a final numeric performance rating at an end of the predetermined time period for each of one or more performance elements for a rate. Calculating, based on the one or more numeric performance ratings received from the rater, a performance score for each of the one or more performance elements may comprise calculating an average or a weighted average of the one or more interim numeric performance ratings and the final numeric performance rating for each of the one or more performance elements over a predetermined time period.

Calculating a weighted average of the one or more interim numeric performance ratings and the final numeric performance rating for each of the one or more performance elements over a predetermined time period may comprise assigning a fifty percent weight to an average of the one or more interim numeric performance ratings and a fifty percent weight to the final numeric performance rating.

The processor may further be configured for calculating an overall performance score for each of the plurality of ratees by averaging the calculated performance score for each of the one or more performance elements for each of the plurality of ratees. The inflation coefficient may be calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

The processor may further be configured for receiving from a workgroup rater a numeric workgroup performance rating for each of a plurality of workgroups, and adjusting the calculated performance score for each of the one or more performance elements for each of the plurality of ratees based on the workgroup performance ratings for some or all workgroups to which each ratee belongs.

The processor may further be configured for calculating a weighted value of each workgroup performance rating by multiplying each workgroup performance rating by a number of ratees in the corresponding workgroup, calculating a workgroup inflation coefficient which provides a numeric indicator of how inflated the numeric workgroup performance ratings received from the workgroup rater are compared to a predefined workgroup normalization average, and calculating an inflation adjusted workgroup performance rating for each workgroup by multiplying each workgroup performance rating by the workgroup inflation coefficient. The inflation coefficient may be calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance rating for the workgroups rated by the same rater.

Each workgroup may comprise at least one supervisor and at least one subordinate of that supervisor; wherein the workgroup rater for each workgroup comprises a supervisor of at least one supervisor in the respective workgroup.

Each workgroup may comprise at least one supervisor and at least one subordinate of that supervisor; wherein the workgroup rater for each workgroup comprises a direct supervisor of a top level supervisor in the respective workgroup.

In another embodiment of the invention, a system for human resource comprises a processor configured for: receiving from a rater one or more numeric performance ratings for each of one or more performance elements for each of a plurality of ratees over a predetermined period of time, calculating, based on the one or more numeric performance ratings received from the rater, a performance score for each of the one or more performance elements for each of the plurality of ratees over the predetermined time period, calculating an inflation coefficient which provides a numeric indicator of how inflated the one or more numeric performance ratings received from the rater are compared to a predefined normalization average, calculating an inflation adjusted performance score for each of the one or more performance elements for each of the plurality of ratees by multiplying each of the one or more performance elements for each of the plurality of ratees by the inflation coefficient, receiving from a workgroup rater a numeric workgroup performance rating for each of a plurality of workgroups, and adjusting the inflation adjusted performance score for each of the plurality of performance elements for each of the plurality of ratees based on the workgroup performance ratings for some or all workgroups to which each ratee belongs.

The processor may further be configured for calculating a weighted value of each workgroup performance rating by multiplying each workgroup performance rating by a number of ratees in the corresponding workgroup, calculating a workgroup inflation coefficient which provides a numeric indicator of how inflated the numeric workgroup performance ratings received from the workgroup rater are compared to a predefined workgroup normalization average, and calculating an inflation adjusted workgroup performance rating for each workgroup by multiplying each workgroup performance rating by the workgroup inflation coefficient. The workgroup inflation coefficient may be calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance ratings for the workgroups rated by the same rater.

The inflation coefficient may be calculated by I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the performance ratings received from the rater.

The processor may further be configured for calculating an inflation number which provides a numeric display of how inflated the one or more numeric performance ratings received from the rater are compared to the predefined normalization average, and displaying the calculated inflation number. The inflation number may be calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

Calculating, based on the one or more numeric performance ratings received from the rater, a performance score for each of the one or more performance elements may comprise calculating an average of the one or more numeric performance ratings for each of the one or more performance elements over a predetermined time period.

Receiving from a rater one or more numeric performance ratings for each of one or more performance elements for a ratee over a predetermined period of time may comprise receiving from a rater one or more interim numeric performance ratings over the predetermined time period and a final numeric performance rating at an end of the predetermined time period for each of one or more performance elements for a rate. Calculating, based on the one or more numeric performance ratings received from the rater, a performance score for each of the one or more performance elements may comprise calculating an average or a weighted average of the one or more interim numeric performance ratings and the final numeric performance rating for each of the one or more performance elements over a predetermined time period.

The processor may further be configured for calculating an overall performance score for each of the plurality of ratees by averaging the calculated performance score for each of the one or more performance elements for each of the plurality of ratees. The inflation coefficient may be calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

The application server 10 and user client machines 41, 42, 43 typically each comprise a microprocessor-based computing device, such as a computer (desktop, laptop, tablet, etc.). Such a computing device may have an internal structure that contains a system bus, where a bus is a set of hardware lines used for data transfer among the components of a computer. The bus is essentially a shared conduit that connects different elements of a computer system (e.g., processor, disk storage, memory, input/output ports, network ports, etc.) that enables the transfer of information between the elements. Attached to system bus is an I/O device interface for connecting various input and output devices (e.g., displays, printers, speakers, microphones, etc.) to the computer. Alternatively, the I/O devices may be connected via one or more I/O processors attached to system bus. A network interface allows the computer to connect to various other devices attached to a network (e.g., network 30 of FIG. 1). A memory provides volatile storage for computer software instructions and data used to implement an embodiment of the present invention. Disk storage provides non-volatile storage for computer software instructions and data used to implement an embodiment of the present invention. A central processor unit is also attached to system bus and provides for the execution of computer instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. If the service is also available to applications as a REpresentational State Transfer (REST) interface, then launching applications could use a scripting language like JavaScript to access the REST interface. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, tablet computer, minicomputer, mainframe, server, cell phone, smartphone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A computer-implemented method for human resource management, comprising:
receiving from a rater one or more numeric performance ratings for each of one or more performance elements for each of a plurality of ratees over a predetermined period of time;
calculating, based on the one or more numeric performance ratings received from the rater, a performance score for each of the one or more performance elements for each of the plurality of ratees over the predetermined time period;
calculating an inflation coefficient which provides a numeric indicator of how inflated the one or more numeric performance ratings received from the rater are compared to a predefined normalization average;
calculating an inflation adjusted performance score for each of the one or more performance elements for each of the plurality of ratees by multiplying each of the one or more performance elements for each of the plurality of ratees by the inflation coefficient; and
displaying the inflation adjusted performance score for each of the one or more performance elements for each of the plurality of ratees.

2. The method of claim 1, wherein the inflation coefficient is calculated by
I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the one or more performance ratings received from the rater.

3. The method of claim 2, further comprising:
calculating an inflation number which provides a numeric display of how inflated the one or more numeric performance ratings received from the rater are compared to the predefined normalization average; and
displaying the calculated inflation number;
wherein the inflation number is calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

4. The method of claim 1, wherein calculating, based on the one or more numeric performance ratings received from the rater, a performance score for each of the one or more performance elements comprises calculating an average of the one or more numeric performance ratings for each of the one or more performance elements over a predetermined time period.

5. The method of claim 1, wherein receiving from a rater one or more numeric performance ratings for each of one or more performance elements for a ratee over a predetermined period of time comprises receiving from a rater one or more interim numeric performance ratings over the predetermined time period and a final numeric performance rating at an end of the predetermined time period for each of one or more performance elements for a ratee; and
wherein calculating, based on the one or more numeric performance ratings received from the rater, a performance score for each of the one or more performance elements comprises calculating an average or a weighted average of the one or more interim numeric performance ratings and the final numeric performance rating for each of the one or more performance elements over a predetermined time period.

6. The method of claim 5, wherein calculating a weighted average of the one or more interim numeric performance ratings and the final numeric performance rating for each of the one or more performance elements over a predetermined time period comprises assigning a fifty percent weight to an average of the one or more interim numeric performance ratings and a fifty percent weight to the final numeric performance rating.

7. The method of claim 1, further comprising:
calculating an overall performance score for each of the plurality of ratees by averaging the calculated performance score for each of the one or more performance elements for each of the plurality of ratees;
wherein the inflation coefficient is calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

8. The method of claim 1, further comprising:
receiving from a workgroup rater a numeric workgroup performance rating for each of a plurality of workgroups; and
adjusting the calculated performance score for each of the one or more performance elements for each of the plurality of ratees based on the workgroup performance ratings for some or all workgroups to which each ratee belongs.

9. The method of claim 8, further comprising:
calculating a weighted value of each workgroup performance rating by multiplying each workgroup performance rating by a number of ratees in the corresponding workgroup;
calculating a workgroup inflation coefficient which provides a numeric indicator of how inflated the numeric workgroup performance ratings received from the workgroup rater are compared to a predefined workgroup normalization average; and
calculating an inflation adjusted workgroup performance rating for each workgroup by multiplying each workgroup performance rating by the workgroup inflation coefficient;
wherein the inflation coefficient is calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance rating for the workgroups rated by the same rater.

10. A computer program product for human resource management, the computer program product comprising a non-transitory computer readable storage medium having computer readable program code embodied therewith, the computer readable program code comprising:
computer readable program code configured for receiving from a rater one or more numeric performance ratings for each of one or more performance elements for each of a plurality of ratees over a predetermined period of time;
computer readable program code configured for calculating, based on the one or more numeric performance ratings received from the rater, a performance score for each of the one or more performance elements for each of the plurality of ratees over the predetermined time period;
computer readable program code configured for calculating an inflation coefficient which provides a numeric indicator of how inflated the one or more numeric performance ratings received from the rater are compared to a predefined normalization average;
computer readable program code configured for calculating an inflation adjusted performance score for each of the one or more performance elements for each of the plurality of ratees by multiplying each of the one or more performance elements for each of the plurality of ratees by the inflation coefficient; and
computer readable program code configured for displaying the inflation adjusted performance score for each of the one or more performance elements for each of the plurality of ratees.

11. The computer program product of claim 10, wherein the inflation coefficient is calculated by
I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the one or more performance ratings received from the rater.

12. The computer program product of claim 10, further comprising:
computer readable program code configured for calculating an inflation number which provides a numeric display of how inflated the one or more numeric performance ratings received from the rater are compared to the predefined normalization average; and
computer readable program code configured for displaying the calculated inflation number;
wherein the inflation number is calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

13. The computer program product of claim 10, wherein calculating, based on the one or more numeric performance ratings received from the rater, a performance score for each of the one or more performance elements comprises calculating an average of the one or more numeric performance ratings for each of the one or more performance elements over a predetermined time period.

14. The computer program product of claim 10, wherein receiving from a rater one or more numeric performance ratings for each of one or more performance elements for a ratee over a predetermined period of time comprises receiving from a rater one or more interim numeric performance ratings over the predetermined time period and a final numeric performance rating at an end of the predetermined time period for each of one or more performance elements for a ratee; and
wherein calculating, based on the one or more numeric performance ratings received from the rater, a performance score for each of the one or more performance elements comprises calculating an average or a weighted average of the one or more interim numeric performance ratings and the final numeric performance rating for each of the one or more performance elements over a predetermined time period.

15. The computer program product of claim 14, wherein calculating a weighted average of the one or more interim numeric performance ratings and the final numeric performance rating for each of the one or more performance elements over a predetermined time period comprises assigning a fifty percent weight to an average of the one or more interim numeric performance ratings and a fifty percent weight to the final numeric performance rating.

16. The computer program product of claim 10, further comprising:
computer readable program code configured for calculating an overall performance score for each of the plurality of ratees by averaging the calculated performance score for each of the one or more performance elements for each of the plurality of ratees;
wherein the inflation coefficient is calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

17. The computer program product of claim 10, further comprising:
computer readable program code configured for receiving from a workgroup rater a numeric workgroup performance rating for each of a plurality of workgroups; and
computer readable program code configured for adjusting the calculated performance score for each of the one or more performance elements for each of the plurality of ratees based on the workgroup performance ratings for some or all workgroups to which each ratee belongs.

18. The computer program product of claim 17, further comprising:
computer readable program code configured for calculating a weighted value of each workgroup performance rating by multiplying each workgroup performance rating by a number of ratees in the corresponding workgroup;
computer readable program code configured for calculating a workgroup inflation coefficient which provides a numeric indicator of how inflated the numeric workgroup performance ratings received from the workgroup rater are compared to a predefined workgroup normalization average; and
computer readable program code configured for calculating an inflation adjusted workgroup performance rating for each workgroup by multiplying each workgroup performance rating by the workgroup inflation coefficient;
wherein the inflation coefficient is calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance rating for the workgroups rated by the same rater.

19. A computer-implemented method for human resource management, comprising:
receiving from a rater one or more numeric performance ratings for each of one or more performance elements for each of a plurality of ratees over a predetermined period of time;
calculating, based on the one or more numeric performance ratings received from the rater, a performance score for each of the one or more performance elements for each of the plurality of ratees over the predetermined time period;
calculating an inflation coefficient which provides a numeric indicator of how inflated the one or more numeric performance ratings received from the rater are compared to a predefined normalization average;
calculating an inflation adjusted performance score for each of the one or more performance elements for each of the plurality of ratees by multiplying each of the one or more performance elements for each of the plurality of ratees by the inflation coefficient;
receiving from a workgroup rater a numeric workgroup performance rating for each of a plurality of workgroups; and
adjusting the inflation adjusted performance score for each of the plurality of performance elements for each of the plurality of ratees based on the workgroup performance ratings for some or all workgroups to which each ratee belongs.

20. The method of claim 19, further comprising:
calculating a weighted value of each workgroup performance rating by multiplying each workgroup performance rating by a number of ratees in the corresponding workgroup;
calculating a workgroup inflation coefficient which provides a numeric indicator of how inflated the numeric workgroup performance ratings received from the workgroup rater are compared to a predefined workgroup normalization average; and
calculating an inflation adjusted workgroup performance rating for each workgroup by multiplying each workgroup performance rating by the workgroup inflation coefficient;
wherein the workgroup inflation coefficient is calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance ratings for the workgroups rated by the same rater.

21. The method of claim 19, wherein the inflation coefficient is calculated by
I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the performance ratings received from the rater.

22. The method of claim 21, further comprising:
calculating an inflation number which provides a numeric display of how inflated the one or more numeric performance ratings received from the rater are compared to the predefined normalization average; and
displaying the calculated inflation number;
wherein the inflation number is calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

23. The method of claim 19, wherein calculating, based on the one or more numeric performance ratings received from the rater, a performance score for each of the one or more performance elements comprises calculating an average of the one or more numeric performance ratings for each of the one or more performance elements over a predetermined time period.

24. The method of claim 19, wherein receiving from a rater one or more numeric performance ratings for each of one or more performance elements for a ratee over a predetermined period of time comprises receiving from a rater one or more interim numeric performance ratings over the predetermined time period and a final numeric performance rating at an end of the predetermined time period for each of one or more performance elements for a ratee; and
wherein calculating, based on the one or more numeric performance ratings received from the rater, a performance score for each of the one or more performance elements comprises calculating an average or a weighted average of the one or more interim numeric performance ratings and the final numeric performance rating for each of the one or more performance elements over a predetermined time period.

25. The method of claim 19, further comprising:
calculating an overall performance score for each of the plurality of ratees by averaging the calculated performance score for each of the one or more performance elements for each of the plurality of ratees;
wherein the inflation coefficient is calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.

26. A computer program product for human resource management, the computer program product comprising a non-transitory computer readable storage medium having computer readable program code embodied therewith, the computer readable program code comprising:
computer readable program code configured for receiving from a rater one or more numeric performance ratings for each of one or more performance elements for each of a plurality of ratees over a predetermined period of time;
computer readable program code configured for calculating, based on the one or more numeric performance ratings received from the rater, a performance score for each of the one or more performance elements for each of the plurality of ratees over the predetermined time period;
computer readable program code configured for calculating an inflation coefficient which provides a numeric indicator of how inflated the one or more numeric performance ratings received from the rater are compared to a predefined normalization average;
computer readable program code configured for calculating an inflation adjusted performance score for each of the one or more performance elements for each of the plurality of ratees by multiplying each of the one or more performance elements for each of the plurality of ratees by the inflation coefficient;
computer readable program code configured for receiving from a workgroup rater a numeric workgroup performance rating for each of a plurality of workgroups; and
computer readable program code configured for adjusting the inflation adjusted performance score for each of the plurality of performance elements for each of the plurality of ratees based on the workgroup performance ratings for some or all workgroups to which each ratee belongs.

27. The computer program product of claim 26, further comprising:
computer readable program code configured for calculating a weighted value of each workgroup performance rating by multiplying each workgroup performance rating by a number of ratees in the corresponding workgroup;
computer readable program code configured for calculating a workgroup inflation coefficient which provides a numeric indicator of how inflated the numeric workgroup performance ratings received from the workgroup rater are compared to a predefined workgroup normalization average; and
computer readable program code configured for calculating an inflation adjusted workgroup performance rating for each workgroup by multiplying each workgroup performance rating by the workgroup inflation coefficient;
wherein the workgroup inflation coefficient is calculated by W=(D×R)/U, where W is the workgroup inflation coefficient, D is the predefined workgroup normalization average, R is a total number of ratees in the plurality of workgroups rated by a given rater, and U is a sum of the weighted values of the workgroup performance ratings for the workgroups rated by the same rater.

28. The computer program product of claim 26, wherein the inflation coefficient is calculated by
I=(D×N)/S, where I is the inflation coefficient, D is the predefined normalization average, N is a total number of performance scores calculated over the predetermined time period based on the one or more performance ratings received from the rater, and S is a sum of the performance scores calculated over the predetermined time period based on the performance ratings received from the rater.

29. The computer program product of claim 28, further comprising:
computer readable program code configured for calculating an inflation number which provides a numeric display of how inflated the one or more numeric performance ratings received from the rater are compared to the predefined normalization average; and
computer readable program code configured for displaying the calculated inflation number;
wherein the inflation number is calculated by F=X+(1−I)×D², where F is the inflation number, I is the inflation coefficient, D is the predefined normalization average, and X may be any number whose value is predefined to be indicative of no inflation, such that an amount by which F deviates from X indicates how inflated or deflated the one or more numeric performance ratings received from the rater are compared to the predefined normalization average.

30. The computer program product of claim 26, wherein calculating, based on the one or more numeric performance ratings received from the rater, a performance score for each of the one or more performance elements comprises calculating an average of the one or more numeric performance ratings for each of the one or more performance elements over a predetermined time period.

31. The computer program product of claim 26, wherein receiving from a rater one or more numeric performance ratings for each of one or more performance elements for a ratee over a predetermined period of time comprises receiving from a rater one or more interim numeric performance ratings over the predetermined time period and a final numeric performance rating at an end of the predetermined time period for each of one or more performance elements for a ratee; and
wherein calculating, based on the one or more numeric performance ratings received from the rater, a performance score for each of the one or more performance elements comprises calculating an average or a weighted average of the one or more interim numeric performance ratings and the final numeric performance rating for each of the one or more performance elements over a predetermined time period.

32. The computer program product of claim 26, further comprising:
computer readable program code configured for calculating an overall performance score for each of the plurality of ratees by averaging the calculated performance score for each of the one or more performance elements for each of the plurality of ratees;
wherein the inflation coefficient is calculated by I=(D×N)/S, where I is the inflation coefficient, D is the predefined normalization average, N is a total number of overall performance scores calculated over the predetermined time period based on the performance ratings received from the rater, and S is a sum of the overall performance scores calculated over the predetermined time period based on the performance ratings received from the rater.
